(19) United States
(12) Patent Application Publication
(10) Pub. No.: US 2009/0326986 A1
(43) Pub. Date: Dec. 31, 2009

(54) AUTOMATED IMAGE ACQUISITION NOTIFICATION

(75) Inventor: Kevin M. CRUCS, Akron, OH (US)

Correspondence Address: HAHN LOESER & PARKS, LLP, One GOJO Plaza, Suite 300, AKRON, OH, 44311-1076, US

(73) Assignee: APTERYX, INC., Akron, OH (US)

(21) Appl. No.: 12/546,280

(22) Filed: Aug. 24, 2009

Related U.S. Application Data
(63) Continuation-in-part of application No. 11/565,683, filed on Dec. 1, 2006.

(51) Int. Cl. G06Q 50/00; H04N 7/18

(52) U.S. Cl. 705/3; 348/77

(57) ABSTRACT

A system and physical computer-readable media for automatic image acquisition notification and routing. A visual and/or audible indication is provided to a user of an application to indicate to the user that image acquisition has occurred. At least one digital image is acquired at a local location using an imaging modality, and an image acquisition notification message is transmitted, (e.g., via a network) to a remote location. The image acquisition notification message is automatically received at the remote location and at least one associated digital image is automatically displayed at the remote location in response to receiving the image acquisition notification message.

This U.S. patent application is a continuation-in-part (CIP) of pending U.S. patent application Ser. No. 11/565,683 filed on Dec. 1, 2006 and which is incorporated by reference herein in it entirety.

### TECHNICAL FIELD

Certain embodiments of the present invention relate to image acquisition and notification (e.g., in telemedicine). More particularly, certain embodiments of the present invention relate to systems for automatic image acquisition notification and routing to a medical practitioner.

### BACKGROUND

In a typical medical environment, where a physician desires to have medical images taken of a patient, a worklist system (e.g., a DICOM compatible system) may be employed where the physician makes a request to a broker who then generates a request to an imaging modality technician (e.g., an X-ray technician). The technician queries the worklist system and receives the request. Initially, the status of the request is “to process”, for example. When the technician processes the request (i.e., acquires the images), the status of the request is changed to “processed”. The acquired images are typically archived, for example, on a PACS system.

The requesting physician may periodically check the archiving system by performing a query to determine whether or not the requested images are available. This can be time-consuming and frustrating for the physician. Alternatively, a notification may be sent to the physician to make the physician aware that the images are available. This may help to prevent the physician from having to periodically check if the images are available by query. However, once notified, the physician may still have to go through the process of retrieving the images from an archiving system. In order to retrieve the images, the physician may need to become aware of specific codes, directories and/or or file names in order to access the images. Such a retrieving process by the physician can also be time-consuming and frustrating, for example, if the physician is given the wrong directory information, or if the physician incorrectly types in the information needed to access the images from the archive.

Further limitations and disadvantages of conventional, traditional, and proposed approaches will become apparent to one of skill in the art, through comparison of such systems and methods with the present invention as set forth in the remainder of the present application with reference to the drawings.

### SUMMARY

In accordance with various embodiments of the present invention, a visual and/or audible indication is provided to a user of an application to indicate to the user that image acquisition has occurred.

An embodiment of the present invention comprises a system for automatic image acquisition notification and routing. The system includes means for acquiring at least one digital image for an imaging modality at a local location. The system further includes means for saving at least one acquired digital image as an image object (e.g., an image file or a link). The system also includes means for generating an image acquisition notification message at the local location. The system further includes means for transmitting an image acquisition notification message from the local location to a remote location. The means for transmitting may be wired, wireless, or a combination thereof. The system also includes means for automatically receiving a transmitted image acquisition notification message at the remote location. The system further includes means for automatically displaying at least one acquired digital image at the remote location in response to receiving an image acquisition notification message. The means for generating an image acquisition notification message may include means for automatically generating an image acquisition notification message in response to acquiring and saving at least one digital image. The means for transmitting an image acquisition notification message may include means for automatically transmitting an image acquisition notification message in response to generating an image acquisition notification message. The system may further include means for selecting the remote location at the local location. The system may also include means for automatically displaying an image acquisition notification message at the remote location in response to receiving an image acquisition notification message. The means for generating an image acquisition notification message may include means for incorporating an image object into an image acquisition notification message. Furthermore, the means for generating an image acquisition notification message may include means for incorporating a link in an image acquisition notification message to where an image object is saved. The means for generating an image acquisition notification message may include means for incorporating a dialogue box in an image acquisition notification message containing identifying information. The means for generating an image acquisition notification message may include means for incorporating patient information in an image acquisition message. The system may also include means for producing an audible sound at the remote location in response to receiving an image acquisition notification message. In accordance with an embodiment of the present invention, the means for transmitting and receiving an image acquisition notification message operates in accordance with a Digital Imaging and Communications in Medicine (DICOM) standard protocol. In accordance with another embodiment of the present invention, the means for transmitting and receiving an image acquisition notification message operates in accordance with a non-DICOM protocol. The means for saving at least one digital image includes means for storing at one or more of the local location, the remote location, and a third-party location. The system may further include means for placing a received image acquisition notification message in a queue of image acquisition notification messages at the remote location. The system may also include means for selecting a received image acquisition notification message from a queue of image acquisition notification messages at the remote location, and means for displaying at least one acquire digital image at the remote location in response to selecting a received image acquisition notification message from a queue of image acquisition notification messages. The system may further include means for transmitting an image acquisition request from the remote location to the local location. The system may also include means for receiving an image acquisition request at the local location. The system may further include means for displaying an image acquisition request at the local location.

Another embodiment of the present invention comprises a physical computer-readable medium encoded with computer-executable instructions for automatic image acquisition notification and routing. The computer-executable instructions include program code for facilitating the acquiring of at least one digital image for an imaging modality. The computer-executable instructions further include program code for facilitating the saving of at least one acquired digital image as an image object. The computer-executable instructions also include program code for facilitating the generating of an image acquisition notification message. The computer-executable instructions further include program code for facilitating the transmitting of an image acquisition notification message to a remote location. The program code for facilitating the saving of at least one acquired digital image as an image object may include program code for facilitating the automatic saving of at least one acquired digital image as an image object in response to acquiring at least one digital image. The program code for facilitating the generating of an image acquisition notification message may include program code for facilitating the automatic generating of an image acquisition notification message in response to saving at least one acquired digital image. The program code for facilitating the transmitting of an image acquisition notification message may include program code for facilitating the automatic transmitting of an image acquisition notification message in response to generating an image acquisition notification message. The computer-executable instructions may further include program code for facilitating the selecting of the remote location. The program code for facilitating the generating of an image acquisition notification message may include program code for facilitating the incorporating of an image object into an image acquisition notification message. The program code for facilitating the generating of an image acquisition notification message may include program code for facilitating the incorporating of a link into an image acquisition notification message to where an image object is saved. The program code for generating an image acquisition notification message may include program code for facilitating the incorporating of a dialogue box containing identifying information into an image acquisition notification message. The program code for facilitating the generating of an image acquisition notification message may include program code for facilitating the incorporating of patient information into an image acquisition notification message. The program code for facilitating the generating and transmitting of an image acquisition notification message may operate in accordance with a DICOM standard protocol. The program code for facilitating the generating and transmitting of an image acquisition notification message may operate in accordance with a non-DICOM protocol. The program code for facilitating the saving of at least one acquired digital image as an image object may include program code for facilitating the storing of at least one image object. The computer-executable instructions may further include program code for facilitating the receiving of an image acquisition request form the remote location. The computer-executable instructions may also include program code for facilitating the displaying of an image acquisition request.

A further embodiment of the present invention comprises a physical computer-readable medium encoded with computer-executable instructions for automatic image acquisition notification and routing. The computer-executable instructions include program code for facilitating the automatic receiving of an image acquisition notification message. The computer-executable instructions further include program code for facilitating the automatic displaying of at least one digital image in response to receiving an image acquisition notification message. The computer-executable instructions may further include program code for facilitating the automatic displaying of an image acquisition notification message in response to receiving an image acquisition notification message. The computer-executable instructions may also include program code for facilitating the automatic extracting of at least one digital image from an image acquisition notification message. The computer-executable instructions may also include program code for facilitating the automatic activating of a link in an image acquisition notification message linking to where at least one digital image is saved. The computer-executable instructions may also include program code for facilitating the automatic activating of the production of an audible sound in response to receiving an image acquisition notification message. The program code for facilitating the receiving of an image acquisition notification message may operate in accordance with a DICOM standard protocol. The program code for facilitating the receiving of an image acquisition notification message may operate in accordance with a non-DICOM protocol. The computer-executable instructions may further include program code for facilitating the automatic placing of a received image acquisition notification message in a queue of image acquisition notification messages. The computer-executable instructions may further include program code for facilitating the selecting of a received image acquisition notification message from a queue of image acquisition notification messages, and for facilitating the displaying of at least one acquired digital image in response to selecting a received image acquisition notification message from a queue of image acquisition notification messages. The computer-executable instructions may also include program code for facilitating the transmitting of an image acquisition request to an image acquisition location.

These and other advantages and novel features of the present invention, as well as details of an illustrated embodiment thereof, will be more fully understood from the following description and drawings.

### BRIEF DESCRIPTION OF THE DRAWINGS

FIG. 1 is a flowchart of an exemplary embodiment of a method of image acquisition notification, in accordance with various aspects of the present invention;

FIG. 2 is a schematic block diagram of an exemplary system for implementing the method of FIG. 1, in accordance with an embodiment of the present invention;

FIG. 3 illustrates a first exemplary embodiment of an image acquisition notification message being displayed in a window of an application on a display of the computer-based platform of FIG. 2 as part of the method of FIG. 1, in accordance with various aspects of the present invention;

FIG. 4 illustrates an exemplary embodiment of digital images of a patient being displayed on the display of the computer-based platform of FIG. 2 as part of the method of FIG. 1, in accordance with various aspects of the present invention;

FIG. 5 illustrates an exemplary embodiment of digital images of a patient being displayed on the display of the computer-based platform of FIG. 2 along with a dialogue box, in accordance with various aspects of the present invention;

FIG. 6 illustrates a single image, from the images of FIG. 4 or FIG. 5, being displayed on the display of the computer-based platform of FIG. 2, in accordance with various aspects of the present invention;

FIG. 7 illustrates a second exemplary embodiment of an image acquisition notification message being displayed in a window of an application on a display of the computer-based platform of FIG. 2 as part of the method of FIG. 1, in accordance with various aspects of the present invention; and

FIG. 8 illustrates a functionality of an application to allow a user to drag and drop an image(s) into an electronic document in a document application window, in accordance with an embodiment of the present invention.

### DETAILED DESCRIPTION

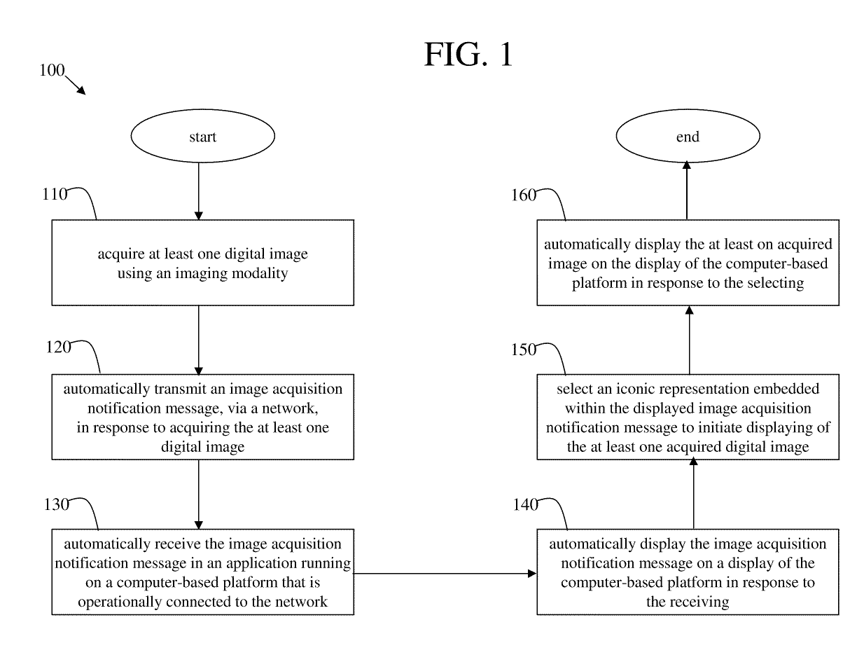

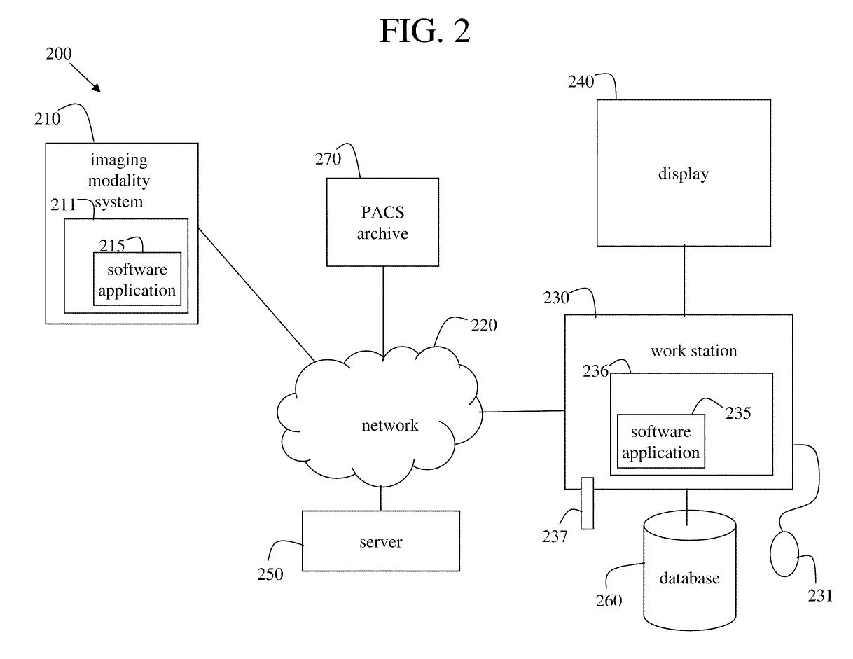

FIG. 1 is a flowchart of an exemplary embodiment of a method 100 of image acquisition notification, in accordance with various aspects of the present invention. FIG. 2 is a schematic block diagram of an exemplary system 200 for implementing the method 100 of FIG. 1, in accordance with an embodiment of the present invention. Embodiments of the present invention, provide a more streamlined way of facilitating the image acquisition and distribution process by providing automatic and immediate notification that acquired images are present, instead of simply notifying a user that a complex query has to now be performed to find the images.

In step 110 of the method 100, at least one digital image is acquired using an imaging modality. For example, the imaging modality may include any one of an X-ray imaging modality, an ultrasound imaging modality, an MR imaging modality, an optical imaging modality (e.g., using a camera), or any other type of imaging modality that uses an imaging system 210 (e.g., an X-ray imaging machine, an ultrasound imaging machine, an MR imaging machine, etc.) to generate digital images (e.g., digital medical images using a medical imaging modality, or digital defect images of defects in manufactured or fabricated items). The imaging modality system 210 is located at a local location (e.g., a hospital). The acquired digital image or images may be saved as a medical image object (e.g., an image file) to, for example, a storage device 211 (e.g., a hard drive) on the imaging modality system 210 at a local location, a storage device (e.g., a hard drive) on a computer-based platform 230 operatively connected to the network 220 at a remote location, a third-party PACS archive 270 operatively connected to the network 220, or a third-party server 250 operatively connected to the network 220. The acquired digital image(s) may be saved automatically in response to acquiring the digital image(s), in accordance with an embodiment of the present invention.

An image acquisition notification message is generated by a software application 215 on the imaging modality system 210, in accordance with an embodiment of the present invention. The image acquisition notification message is automatically generated in response to acquiring and saving at least one digital image, and the image acquisition notification message is automatically transmitted in response to generating the image acquisition notification message, in accordance with an embodiment of the present invention. As part of generating the image acquisition notification message, a medical image object (e.g., an image file) may be incorporated into the image acquisition notification message for transmission. Alternatively, as part of generating the image acquisition notification message, a link may be incorporated into the image acquisition notification message to where a medical image object is saved.

In step 120, the image acquisition notification message is automatically transmitted, via the network 220, in response to acquiring the at least one digital image. In accordance with various embodiments of the present invention, the network 220 may comprise a wired communication network, a wireless communication network, or some combination thereof. The imaging modality system 210 is operationally connected to the network 220. In accordance with an embodiment of the present invention, the image acquisition notification message is transmitted over the network 220 in accordance with a DICOM (digital imaging and communications in medicine) standard protocol. In accordance with an alternative embodiment of the present invention, the image acquisition notification message is transmitted over the network 220 in accordance with a non-DICOM protocol. The software application 215 on the imaging modality system 210 provides the capability for a user of the imaging modality system 210 to select a remote location to which the image acquisition notification message is to be transmitted. For example, a list of remote locations or icons representing remote locations may be displayed to a user and the user is able to use a joystick or some other user interface to position and click on the desired remote location.

In accordance with an embodiment of the present invention, an image acquisition request may be transmitted from a remote location to the imaging modality system 210 at the local location. The imaging modality system 210 along with the software application 215 provide the capability to receive the image acquisition request and to display the image acquisition request on a display of the imaging modality system at the local location. Such a received image acquisition request may be the motivation for starting the method 100. The image acquisition request may include patient identification information and/or remote requesting location information such that an image acquisition notification message may be automatically sent back to the remote location.

In accordance with an embodiment of present invention, the software application 215 may be resident on a physical computer-readable medium having the application 215 of computer-executable instructions for performing the functions described herein which are attributed to the imaging modality system 210 with respect to the image acquisition notification message. Such functions may include receiving and displaying an image acquisition request from a remote location, saving of at least one acquired digital image as an image file, generating an image acquisition notification message, selecting a remote location, and transmitting an image acquisition notification message to the remote location. The physical computer-readable medium may comprise, for example, a hard drive, a compact disk (CD), a floppy disk, a digital video disk (DVD), a memory stick, or any other type of physical computer-readable medium capable of storing or having recorded thereon the computer-executable instructions as described herein. However, the physical computer-readable medium does not include a computer-readable transmission medium such as, for example, an electromagnetic signal.

In step 130, the image acquisition notification message is automatically received in an application 235 (i.e., a software application) running on a computer-based platform 230 that is operationally connected to the network 220 at a remote location. The computer-based platform 230 may be a personal computer (PC), a work station, a hand-held device, or any other processor-based device capable of performing the functions as described herein which are attributed to the computer-based platform 230. In accordance with an embodiment of present invention, the application 235 may be resident on a physical computer-readable medium 236 having the application 235 of computer-executable instructions for performing the functions described herein. The physical computer-readable medium 236 may comprise, for example, a hard drive, a compact disk (CD), a floppy disk, a digital video disk (DVD), a memory stick, or any other type of physical computer-readable medium capable of storing or having recorded thereon the computer-executable instructions as described herein. However, the physical computer-readable medium does not include a computer-readable transmission medium such as, for example, an electromagnetic signal.

In accordance with an embodiment of the present invention, the computer-based platform 230 and a user (e.g., a physician or a dentist) of the computer-based platform 230 are located remotely away from the imaging modality system 210. For example, the imaging modality system 210 and an X-ray technician using the imaging modality system 210 may be located in a hospital, and the work station 230 and physician using the work station 230 may be located miles away in a private doctor's office. As another example, the imaging modality system 210 (e.g., a digital pan imaging system) and an X-ray technician using the imaging modality system 210 may be located in an imaging room of a professional building, and each of a plurality of work stations 230 and associated dentists using each work station may be located in separate operatories of the professional building.

For example, a dental X-ray technician takes a patient out of operatory #2 to the digital pan imaging system, images the patient, selects operatory #2 on the digital pan imaging system (or on a computer operatively connected to the digital pan imaging system) for the acquired images to be sent to operatory #2. When the patient is subsequently returned to operatory #2, the acquired images are already displayed on the display of the workstation in operatory #2. That is, the images are automatically displayed without the dentist in operatory #2 having to do anything to cause the images to be displayed, in accordance with an embodiment of the present invention. This helps with sterilization concerns and infection control.

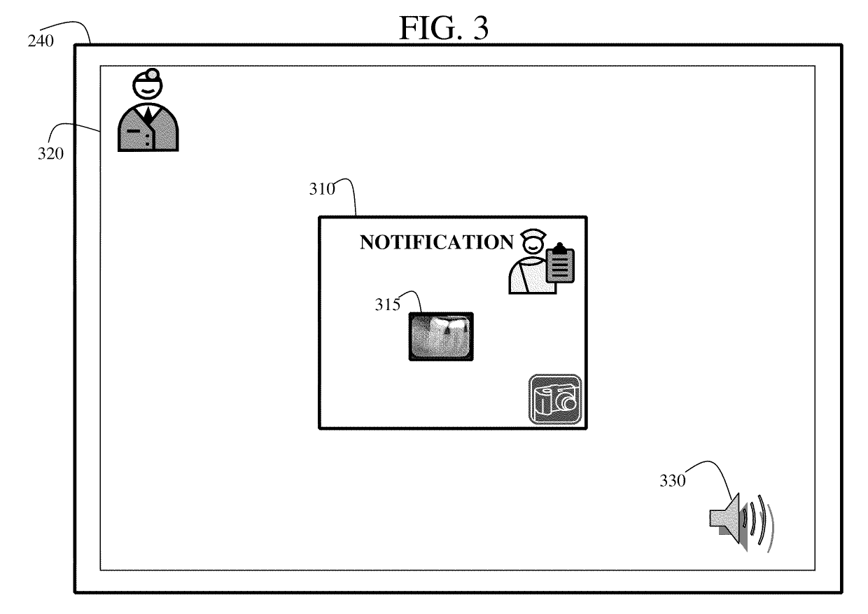

In step 140, the image acquisition notification message is automatically displayed on a display 240 of the computer-based platform 230 in response to the message being received by the application 235 running on the computer-based platform 230. FIG. 3 illustrates a first exemplary embodiment of an image acquisition notification message 310 being displayed in a window 320 of the application 235 on a display 240 of the computer-based platform 230 of FIG. 2 as part of the method 100 of FIG. 1, in accordance with various aspects of the present invention. In accordance with an embodiment of the present application, the image acquisition notification message 310 automatically “pops up” in a displayed window of the application 235 upon reception by the application 235 running on the computer-based platform 230. As an option, the application 235 may also trigger an audible sound 330 that is output by the computer-based platform 230 when the image acquisition notification message 310 “pops up” on the display 240. In accordance with an embodiment of the present invention, the image acquisition notification message 310 includes an iconic representation 315, which is displayed as part of the message 310, and an associated file or files.

In step 150, an iconic representation 315 embedded within the displayed image acquisition notification message 310 is selected (e.g., by a user of the application 235) to initiate displaying of the at least one acquired digital image associated with the notification message. In accordance with an embodiment of the present invention, the iconic representation 315 is an image thumbnail and is selected when a user “clicks” on the image thumbnail using a mouse 231 of the computer-based platform 230, for example.

The user may be, for example, a physician or a dentist. In accordance with an embodiment of the present invention, the user logs into the application 235 running on the computer-based platform 230 in order to access records of the patient. That is, only the particular user (e.g., physician) has permission to access the records of a particular patient. The image acquisition notification message 310 is associated with the user such that only the user, when logged into the application 235, may access the image acquisition notification message 310 for the user's patient. For example, only the permitted user can select the iconic representation 315 to open the file. Also, for example, before acquiring the images with the imaging modality system 210, an X-ray technician may designate an individual (e.g., the patient's physician or dentist) such that only the designated individual can receive the image acquisition notification message 310 when logged into the application 235.

In accordance with an embodiment of the present invention, the image acquisition notification message 310 is displayed on the display 240 of the computer-based platform 230 only when the permitted user is logged into the application 235. In accordance with an alternative embodiment of the present application, the image acquisition notification message 310 is displayed on the display 240 of the computer-based platform 230 no matter who is logged into the application 235. However, only a designated or permitted user (e.g., the dentist of the patient associated with the message 310) may be able to access the message 310.

In step 160, the at least one acquired image is automatically displayed on the display 240 of the computer-based platform 230 in response to selecting the iconic representation 315. The user may then observe the image (or images) on the display 240. Alternatively, to better facilitate infection control and address sterilization concerns, the acquired digital image(s) is automatically displayed on the display 240 at the remote location in response to receiving the image acquisition notification message. For example, upon reception of the image acquisition notification message, the digital image object is automatically extracted from the image acquisition notification message and displayed. As another example, upon reception of the image acquisition notification message, an embedded link in the image acquisition notification message to where a digital image is saved is automatically activated and the image is automatically retrieved and displayed.

As a result, the user of the work station 230 does not have to touch the mouse or keyboard to view the image(s). However, the user may desire to have some minimal interaction with the work station 230 to perform certain display functions such as, for example, zoom/magnification adjustment, brightness adjustment, or contrast adjustment. Furthermore, the user does not have to perform a search or query for the image(s). The image acquisition notification message may contain the image object (e.g., image file) or may contain a link to where the image(s) is saved (e.g., PACS archive 270 or server 250), in accordance with various embodiments of the present invention. The transmitted image acquisition notification message and associated images may or may not be in the context of an identified patient. For compliance with certain HIPAA (Health Insurance Portability and Accountability Act) privacy regulations, it may be desirable to keep patient identity anonymous.

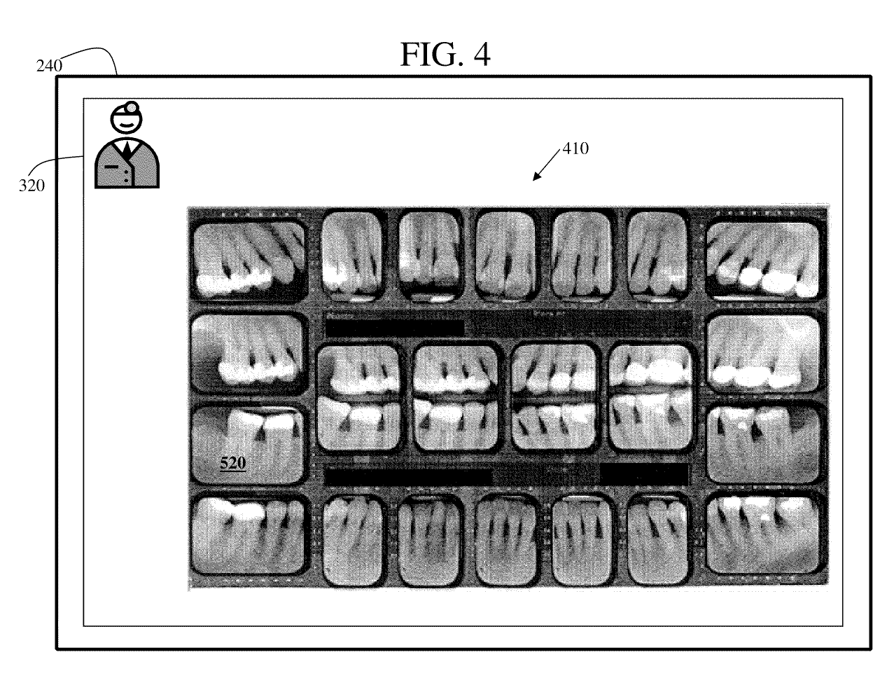

FIG. 4 illustrates an exemplary embodiment of digital images 410 of a patient being displayed on the display 240 of the computer-based platform 230 of FIG. 2 as part of the method 100 of FIG. 1, in accordance with various aspects of the present invention. The images 410 may include a set of dental X-ray images or any other type of images, in accordance with various embodiments of the present invention (e.g., other types of medical images or fabrication images).

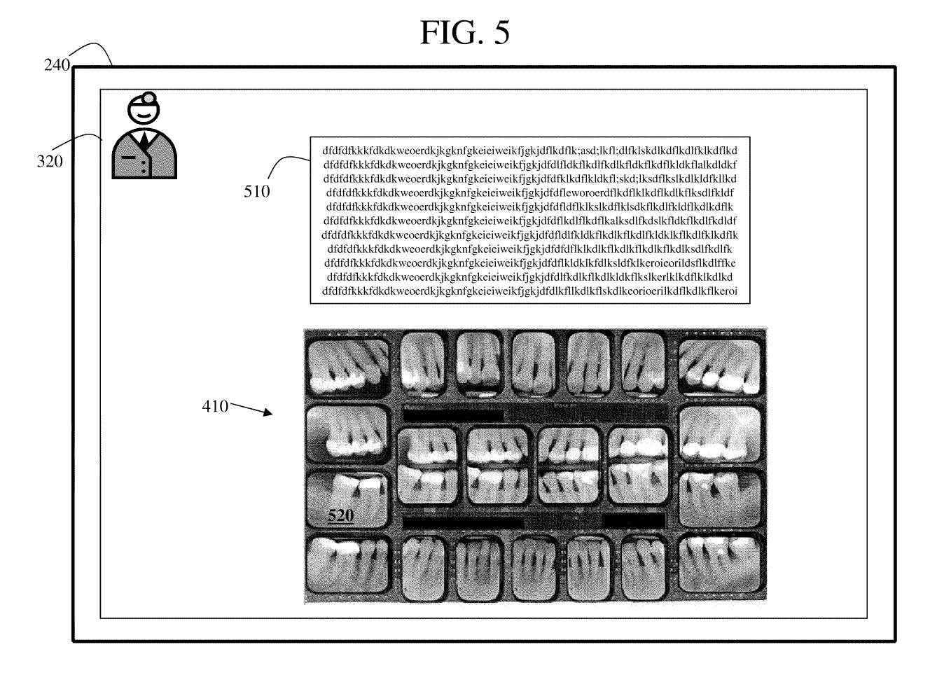

FIG. 5 illustrates an exemplary embodiment of digital images 410 of a patient being displayed on the display 240 of the computer-based platform 230 of FIG. 2 along with a dialogue box 510, in accordance with various aspects of the present invention. The dialogue box 510 may contain identifying information such as patient information, doctor information (e.g., name and number), and/or comments from a technician who acquired the images 410 using an imaging modality system 210. Both the images 410 and the dialogue box 510 are displayed in response to a user selecting the iconic representation 315 or automatically in response to receiving an image acquisition notification message, in accordance with various embodiments of the present invention.

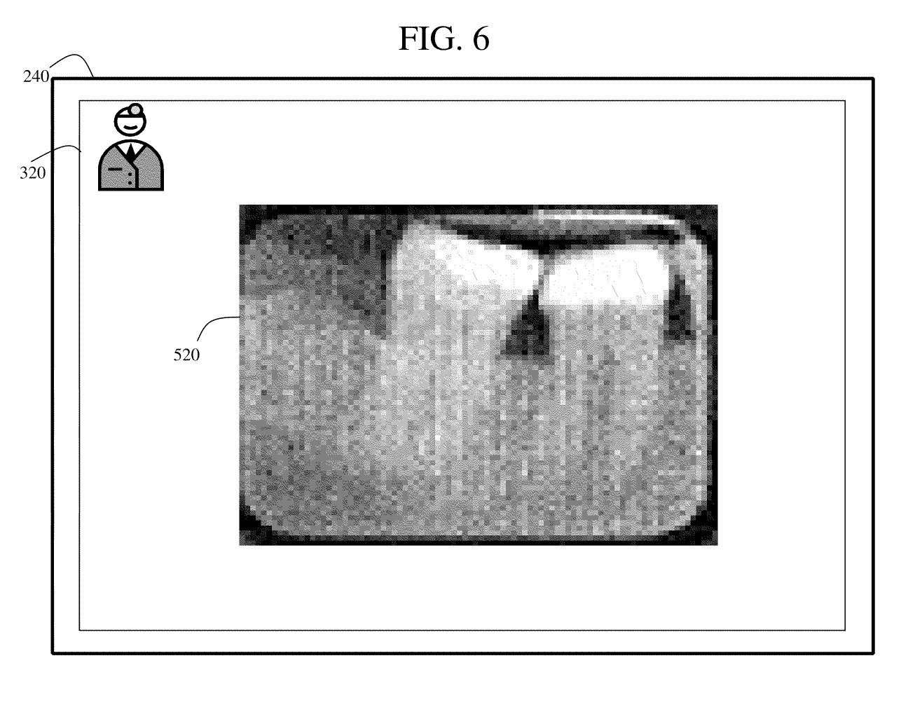

FIG. 6 illustrates a single image 520, from the images 410 of FIG. 4 or FIG. 5, being displayed on the display 240 of the computer-based platform 230 of FIG. 2, in accordance with various aspects of the present invention. When the user is viewing the set of images 410, the user may select (e.g., by clicking with a mouse) any one of the images (e.g., image 520) and view that image 520. The image 520 is displayed on the display 240 in the window 320 of the application 235 such that the image 520 is “blown up” or “enlarged” for better viewing by the user (e.g., by a dentist).

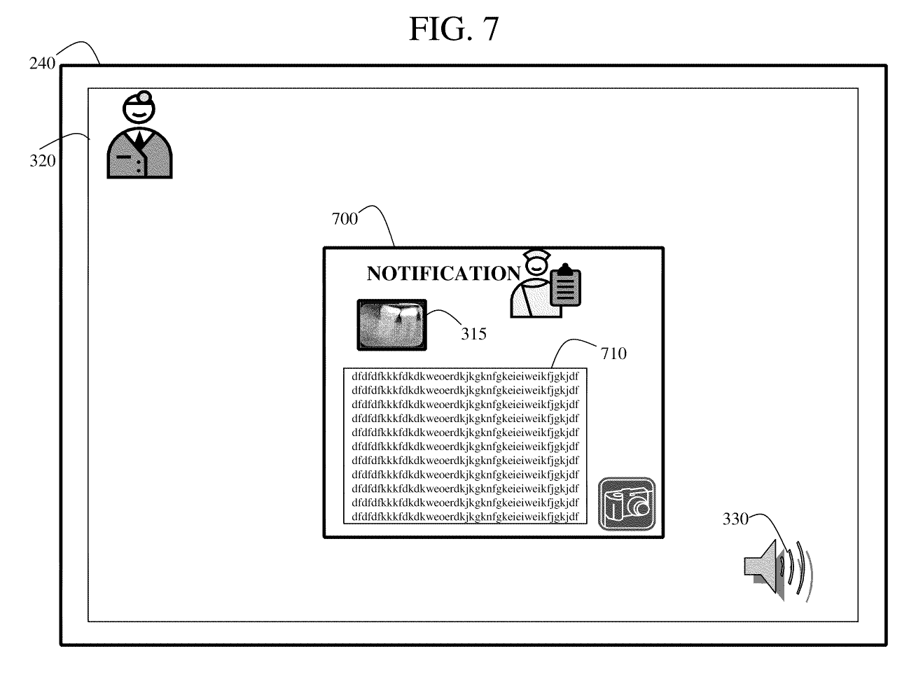

FIG. 7 illustrates a second exemplary embodiment of an image acquisition notification message 700 being displayed in a window 320 of the application 235 on a display 240 of the computer-based platform 230 of FIG. 2 as part of the method 100 of FIG. 1, in accordance with various aspects of the present invention. The displayed notification message 700 includes an iconic representation 315 as well as a dialogue box 710. Again, the dialogue box 710 may contain identifying information and/or comments from a technician who acquired the images 410 using an imaging modality system 210.

In accordance with an embodiment of the present invention, the digital image (or images) received in the image acquisition notification message 310 may be saved by the user of the computer-based platform 230, or automatically. For example, the digital image(s) may be saved as files to a storage device of the computer-based platform 230 such as a hard disk 236, a memory stick 237, or some other digital storage device (e.g., a CD or DVD), using the application 235 running on the computer-based platform 230.

In accordance with another embodiment of the present invention, the digital image(s) may be saved as files by the user to a server 250 operationally connected to the computer-based platform 230 or to the network 220, using the application 235 running on the computer-based platform 230. In accordance with still another embodiment of the present invention, the digital image(s) may be saved by the user to a database 260 operationally connected to the computer-based platform 230 or to the network 220, using the application 235 running on the computer-based platform 230. In accordance with yet another embodiment of the present invention, the digital image(s) may be saved by the user to an archiving device 270 (e.g., a PACS archiving system) operationally connected to the computer-based platform 230 or to the network 220, using the application 235 running on the computer-based platform 230. Just as images may be saved, as described above herein, images may also be deleted, in a similar but opposite manner by the user. Similarly, the image acquisition notification message itself, with all of its constituent parts (e.g., image thumbnail, image file or image object, dialogue box, etc.), may be saved or deleted just as images may be saved or deleted.

When an image acquisition notification message is received by the computer-based platform 230, the software application 235 may place the received image acquisition notification message in a queue of image acquisition notification messages at the remote location. The software application 235 provides the capability for a user to select a received image acquisition notification message from the queue of image acquisition notification messages and for displaying at least one acquired image at the remote location in response to selecting the received image acquisition notification message. As a result, multiple image acquisition notification messages may be handled.

For example, an X-ray specialist may receive multiple image acquisition notification messages at a remote location associated with multiple different patients from a plurality of local imaging locations. The specialist is able to review the associated images in order of reception, or is able to click on a particular image acquisition notification message out of order to view the images associated with that particular image acquisition notification message. The X-ray specialist may or may not have information as to the identity of the patient.

Again, all of the functionality of the application 235 as described herein may be resident on a physical computer-readable medium having computer-executable instructions that provide the functionality when executed on a computer-based platform 230. For example, an embodiment of the present invention comprises a physical computer-readable medium having an application of computer-executable instructions for performing a method comprising automatically receiving an image acquisition notification message, at a computer-based platform running the application of computer-executable instructions, which is automatically transmitted from an imaging modality system over a network in response to the imaging modality system acquiring at least one digital image; automatically displaying the image acquisition notification message, in response to the receiving, on a display of the computer-based platform running the application of computer-executable instructions; allowing selecting of an iconic representation embedded within the displayed image acquisition notification message to initiate displaying of the at least one acquired digital image associated with the notification message, and automatically displaying the at least one acquired digital image on the display of the computer-based platform in response to the selecting. The receiving may be performed in accordance with a DICOM standard protocol, or a non-DICOM protocol, for example.

As another example, another embodiment of the present invention comprises a physical computer-readable medium encoded with computer-executable instructions for facilitating the automatic receiving of an image acquisition notification message, facilitating the automatic displaying of an image acquisition notification message in response to receiving an image acquisition notification message, facilitating the automatic extracting of at least one digital image from an image acquisition notification message or facilitating the automatic activating of a link in an image acquisition notification message linking to where at least one digital image is saved, and for facilitating the automatic displaying of at least one digital image in response to receiving an image acquisition notification message. The computer-executable instructions may further include program code for facilitating the automatic activating of the production of an audible sound in response to receiving an image acquisition notification message.

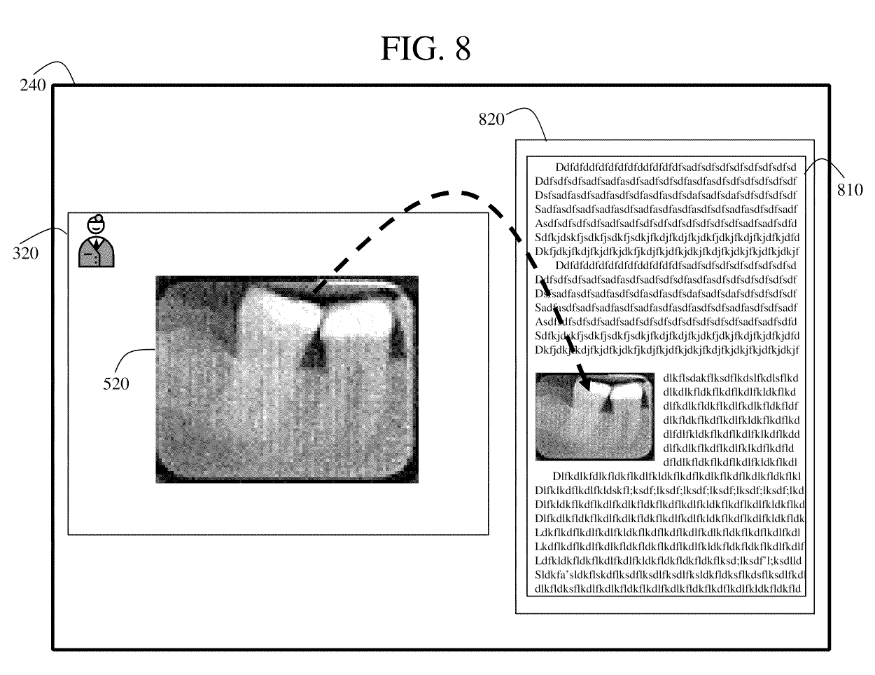

FIG. 8 illustrates a functionality of the application 235 to allow a user to drag and drop an image(s) 520 into an electronic document 810 in a document application window 820, in accordance with an embodiment of the present invention. The document application corresponding to the document application window 820 is an entirely separate application from that of the application 235, in accordance with an embodiment of the present invention. However, both the application 235 and the document application run on the computer-based platform 230 wherein the document application window 820 is compatible with the application 235 such that an image(s) may be dragged from the window 320 and dropped at a location within a document 810 in the document application window 820. In accordance with an alterative embodiment of the present invention, the document application window 820 may be a part of the application 235. That is, a user is able to generate documents using the application 235 and drag and drop images into the documents as described above herein.

In accordance with certain embodiments of the present invention, the location (either physical location or location in cyberspace) of patients and/or physicians may be tracked. The tracked location information may be used to determine where to send an image acquisition notification message. For example, in a facility for servicing many patients in different rooms within the facility, tracking of the patient locations may be desirable in order to send an image acquisition notification message to a room currently occupied by an associated patient. Patients may be tracked within the facility via any of various technologies including, for example, RFID technology and bar code technology. As another example, a physician at a remote location may have a mobile device which may be tracked, for example, via a location-based services (LBS) application. The resultant LBS coordinates may be correlated at a local location to a networked computer or workstation at the remote location. As a result, an image acquisition notification message generated at the local location may be sent to the networked computer or workstation at the remote location. Other tracking scenarios are possible as well, in accordance with various other embodiments of the present invention.

In summary, embodiments of the present invention provide a system and physical computer-readable media for automatic image acquisition notification and routing. A visual and/or audible indication is provided to a user of an application to indicate to the user that image acquisition has occurred. At least one digital image is acquired at a local location using an imaging modality, and an image acquisition notification message is transmitted, (e.g., via a network) to a remote location. The image acquisition notification message is automatically received at the remote location and at least one associated digital image is automatically displayed at the remote location in response to receiving the image acquisition notification message.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A system for automatic image acquisition notification and routing, said system comprising:
means for acquiring at least one digital image for an imaging modality at a local location;
means for saving at least one acquired digital image as an image object;
means for generating an image acquisition notification message at said local location;
means for transmitting an image acquisition notification message from said local location to a remote location;
means for automatically receiving a transmitted image acquisition notification message at said remote location; and
means for automatically displaying at least one acquired digital image at said remote location in response to receiving an image acquisition notification message.

2. The system of claim 1 wherein said means for generating an image acquisition notification message includes means for automatically generating an image acquisition notification message in response to acquiring and saving at least one digital image.

3. The system of claim 1 wherein said means for transmitting an image acquisition notification message includes means for automatically transmitting an image acquisition notification message in response to generating an image acquisition notification message.

4. The system of claim 1 further comprising means for selecting said remote location at said local location.

5. The system of claim 1 further comprising means for automatically displaying an image acquisition notification message at said remote location in response to receiving an image acquisition notification message.

6. The system of claim 1 wherein said means for generating an image acquisition notification message includes means for incorporating an image object into an image acquisition notification message.

7. The system of claim 1 wherein said means for generating an image acquisition notification message includes means for incorporating a link in an image acquisition notification message to where a image object is saved.

8. The system of claim 1 wherein said means for transmitting is wireless.

9. The system of claim 1 wherein said means for transmitting is wired.

10. The system of claim 1 wherein said means for generating an image acquisition notification message includes means for incorporating a dialogue box in an image acquisition notification message containing identifying information.

11. The system of claim 1 wherein said means for generating an image acquisition notification message includes means for incorporating patient information in an image acquisition notification message.

12. The system of claim 1 further comprising means for producing an audible sound at said remote location in response to receiving an image acquisition notification message.

13. The system of claim 1 wherein said means for transmitting and receiving an image acquisition notification message operates in accordance with a DICOM standard protocol.

14. The system of claim 1 wherein said means for transmitting and receiving an image acquisition notification message operates in accordance with a non-DICOM protocol.

15. The system of claim 1 wherein said means for saving at least one digital image includes means for storing at said local location.

16. The system of claim 1 wherein said means for saving at least one digital image includes means for storing at said remote location.

17. The system of claim 1 wherein said means for saving at least one digital image includes means for storing at a third-party location.

18. The system of claim 1 further comprising means for placing a received image acquisition notification message in a queue of image acquisition notification messages at said remote location.

19. The system of claim 1 further comprising means for selecting a received image acquisition notification message from a queue of image acquisition notification messages at said remote location and means for displaying at least one acquired digital image at said remote location in response to selecting a received image acquisition notification message from a queue of image acquisition notification messages.

20. The system of claim 1 further comprising means for transmitting an image acquisition request from said remote location to said local location.

21. The system of claim 1 further comprising means for receiving an image acquisition request at said local location.

22. The system of claim 1 further comprising means for displaying an image acquisition request at said local location.

23. A physical computer-readable medium encoded with computer-executable instructions for automatic image acquisition notification and routing, said computer-executable instructions including program code for:
facilitating the saving of at least one acquired digital image as an image object;
facilitating the generating of an image acquisition notification message; and
facilitating the transmitting of an image acquisition notification message to a remote location.

24. The physical computer-readable medium of claim 23 wherein said program code for facilitating the saving of at least one acquired digital image as an image object includes program code for facilitating the automatic saving of at least one acquired digital image as an image object in response to acquiring at least one digital image.

25. The physical computer-readable medium of claim 23 wherein said program code for facilitating the generating of an image acquisition notification message includes program code for facilitating the automatic generating of an image acquisition notification message in response to saving at least one acquired digital image.

26. The physical computer-readable medium of claim 23 wherein said program code for facilitating the transmitting of an image acquisition notification message includes program code for facilitating the automatic transmitting of an image acquisition notification message in response to generating an image acquisition notification message.

27. The physical computer-readable medium of claim 23 wherein said computer-executable instructions further include program code for facilitating the selecting of said remote location.

28. The physical computer-readable medium of claim 23 wherein said program code for facilitating the generating of an image acquisition notification message includes program code for facilitating the incorporating of an image object into an image acquisition notification message.

29. The physical computer-readable medium of claim 23 wherein said program code for facilitating the generating of an image acquisition notification message includes program code for facilitating the incorporating of a link into an image acquisition notification message to where an image object is saved.

30. The physical computer-readable medium of claim 23 wherein said program code for generating an image acquisition notification message includes program code for facilitating the incorporating of a dialogue box containing identifying information into an image acquisition notification message.

31. The physical computer-readable medium of claim 23 wherein said program code for facilitating the generating of an image acquisition notification message includes program code for facilitating the incorporating of patient information into an image acquisition notification message.

32. The physical computer-readable medium of claim 23 wherein said program code for facilitating the generating and transmitting of an image acquisition notification message operates in accordance with a DICOM standard protocol.

33. The physical computer-readable medium of claim 23 wherein said program code for facilitating the generating and transmitting of an image acquisition notification message operates in accordance with a non-DICOM protocol.

34. The physical computer-readable medium of claim 23 wherein said program code for facilitating the saving of at least one acquired digital image as an image object includes program code for facilitating the storing of at least one image object.

35. The physical computer-readable medium of claim 23 wherein said computer-executable instructions further include program code for facilitating the receiving of an image acquisition request from said remote location.

36. The physical computer-readable medium of claim 23 wherein said computer-executable instructions further include program code for facilitating the displaying of an image acquisition request.

37. A physical computer-readable medium encoded with computer-executable instructions for automatic image acquisition notification and routing, said computer-executable instructions including program code for:
facilitating the automatic receiving of an image acquisition notification message; and
facilitating the automatic displaying of at least one digital image in response to receiving an image acquisition notification message.

38. The physical computer-readable medium of claim 37 wherein said computer-executable instructions further include program code for facilitating the automatic displaying of an image acquisition notification message in response to receiving an image acquisition notification message.

39. The physical computer-readable medium of claim 37 wherein said computer-executable instructions further include program code for facilitating the automatic extracting of at least one digital image from an image acquisition notification message.

40. The physical computer-readable medium of claim 37 wherein said computer-executable instructions further include program code for facilitating the automatic activating of a link in an image acquisition notification message linking to where at least one digital image is saved.

41. The physical computer-readable medium of claim 37 wherein said computer-executable instructions further include program code for facilitating the automatic activating of the production of an audible sound in response to receiving an image acquisition notification message.

42. The physical computer-readable medium of claim 37 wherein said program code for facilitating the receiving of an image acquisition notification message operates in accordance with a DICOM standard protocol.

43. The physical computer-readable medium of claim 37 wherein said program code for facilitating the receiving of an image acquisition notification message operates in accordance with a non-DICOM protocol.

44. The physical computer-readable medium of claim 37 wherein said computer-executable instructions further include program code for facilitating the automatic placing of a received image acquisition notification message in a queue of image acquisition notification messages.

45. The physical computer-readable medium of claim 37 wherein said computer-executable instructions further include program code for facilitating the selecting of a received image acquisition notification message from a queue of image acquisition notification messages, and for facilitating the displaying of at least one acquired digital image in response to selecting a received image acquisition notification message from a queue of image acquisition notification messages.

46. The physical computer-readable medium of claim 37 wherein said computer-executable instructions further include program code for facilitating the transmitting of an image acquisition request to an image acquisition location.
